(19) United States
(12) Patent Application Publication
(10) Pub. No.: US 2005/0015606 A1
(43) Pub. Date: Jan. 20, 2005

(54) Malware scanning using a boot with a non-installed operating system and download of malware detection files

(76) Inventors: Colin John Blamires, Aylesbury (GB); Simon Neil Reed, Wokingham (GB); Malcolm David Binns, Thame (GB)

Correspondence Address: NIXON & VANDERHYE, PC, 1100 N GLEBE ROAD, 8TH FLOOR, ARLINGTON, VA, 22201-4714, US

(21) Appl. No.: 10/620,364

(22) Filed: Jul. 17, 2003

(51) Int. Cl. H04L 9/32

(52) U.S. Cl. 713/188

(57) ABSTRACT

A computer 2 is booted with a removable physical media 10 which bears a clean non-installed operating system. Network support code is also loaded from the removable physical media 10 and used to establish a connection with a remote computer 6, 8. Malware detection files are then downloaded from the remote computer 6, 8 and used to perform a malware detection operation upon the computer 2. Thus, the removable physical media 10 necessary to perform the clean boot may be distributed in advance of a malware outbreak whilst the downloading from a remote computer 6, 8 of the malware detection files ensures that the most up-to-date versions of these files will be used when the removable physical media 10 is employed to conduct a clean boot and trigger a malware detection operation in a malware outbreak situation.

### BACKGROUND OF THE INVENTION

1. Field of the Invention

This invention relates to the field of data processing systems. More particularly, this invention relates to the field of detecting malware, such as, for example, computer viruses, Trojans, worms, banned files and the like.

2. Description of the Prior Art

Many different types of malware threat are known to exist. These malware threats represent a significant risk to the integrity and operation of computer systems. It is known to provide malware detection software and mechanisms which serve to detect the presence of malware upon a computer system and take action such as deleting the malware files, quarantining the malware files, raising alarms, isolating the computers concerned and the like. As malware threats are becoming more sophisticated, it is increasingly difficult to perform a malware scan with a high level of confidence that an element of malware is not in some way subverting or evading that scan.

Known items of malware act to prevent malware detecting and cleaning products from operating correctly and so render themselves undetectable. One way of dealing with this is to “clean boot” a system using a non-installed malware-free operating system before running a non-installed malware scanner using that operating system. The “clean boot” is performed using an operating system stored upon a removable physical media, such as a floppy disk or a CD, which also bears the malware detecting software, including the virus definitions, options and the like. Whilst such an approach is effective at detecting malware, it suffers from significant implementation difficulties.

In the context of a virus outbreak, a system administrator will typically need to “clean boot” an entire site under significant time pressure. In order to properly conduct this activity a large number of copies of the necessary removable physical media bearing the latest malware scanning computer files will need to be created and distributed to enable individual users to boot their systems using these removable physical media. This represents a significant bottleneck. As an alternative, the administrator could choose to build copies of the necessary removable physical media in advance and distribute these to be in place should an outbreak occur. However, version control with this approach represents a difficult task and there would be a significant overhead involved in keeping the removable physical media copies up-to-date and replaced with current versions as the malware detecting software is updated. In this context, it will be appreciated that virus definition data is updated with high frequency and the greatest risk is generally posed by the newest viruses which are only present on the most up-to-date versions of the virus definition data.

It is also known to “network boot” computers whereby an operating system is downloaded from a remote source on start up. However, not all computers have this capability and the operating system download places a disadvantageous load upon network capacity.

### SUMMARY OF THE INVENTION

Viewed from one aspect the present invention provides a removable physical media bearing a computer program operable to control a computer to detecting malware by performing the steps of:
booting said computer with a non-installed operating system read from said removable physical media instead of an installed operating system stored on said computer;
loading network support code for said computer read from said removable physical media;
downloading from a remote computer one or more malware detection files; and
performing malware detection upon said computer using said one or more malware detection files.

The present technique recognises the significant practical problems associated with the known systems and proposes the solution of providing a bootable removable physical media that enables a clean boot to a non-installed operating system to be performed. The removable physical media also bears the necessary network support code to enable downloading from a remote computer of the malware detection files that are needed to perform malware detection. Thus, the removable physical media necessary for a clean boot may be available in advance to computer users whilst the problem of ensuring that the most up-to-date malware detecting files are used is addressed by having these downloaded from a remote computer once the clean boot has taken place.

It will be appreciated that the malware detection files could take a variety of different forms depending upon the nature of the malware detection system concerned. However, particularly preferred embodiments are ones in which the malware detection files include at least one of malware definition data, a malware detecting engine, a malware application shell and malware detection option settings.

In embodiments which download all of these types of file, the complete malware detection mechanism can effectively be downloaded from a remote source and thus the user provided with the most up-to-date version irrespective of the age of the particular removable physical media with which they have been provided.

Whilst it will be appreciated that the step of downloading the malware detection files could be managed in a variety of different ways, such as an automatically running batch or script file, in preferred embodiments of the invention the system loads security management code which is operable to control the downloading. The security management code can be stored upon the removable physical media.

The security of the malware detection mechanism is improved when the connection between the computer upon which malware detection is to be performed and the remote computer is established as a secure network connection, e.g. using authentication and/or encryption.

In preferred embodiments of the invention a firewall computer disposed between the computer upon which malware detection is to be performed and the remote computer is provided to block connections other than the secure network connections referred to above. Thus, a firewall computer can be activated to block connections that might otherwise enable the spreading of an item of malware as part of an outbreak whilst permitting the required connections to enable the clean boot and malware detection program to be completed.

Whilst the non-installed operating system could have a variety of different forms, such as Linux, etc, the technique is particularly well suited to systems in which the non-installed operating system is a Windows PE operating system. The Windows PE operating system has the advantages of incorporating network support and also dealing with different file storage formats.

It will be appreciated that the removable physical media could take a wide variety of different forms, such as an optical disk (CD, DVD etc), a floppy disk, a memory card or a removable disk drive.

The invention is applicable to the detection of a wide variety of different types of malware including, for example, computer viruses, computer Trojans, computer worms, banned computer applications, data associated with malware files and configuration settings of a computer associated with malware files. The malware detection may also serve to quarantine and/or repair the results of malware infection on a system, such as deleting the offending files, quarantining the offending files, repairing registry settings and the like.

Viewed from another aspect the present invention provides a method of detecting malware upon a computer said method comprising the steps of:
booting said computer with a non-installed operating system read from a removable physical media instead of an installed operating system stored on said computer;
loading network support code for said computer read from said removable physical media;
downloading from a remote computer one or more malware detection files; and
performing malware detection upon said computer using said one or more malware detection files.

Viewed from a further aspect the present invention provides a computer operable to detect malware upon said computer by performing the steps of:
booting said computer with a non-installed operating system read from a removable physical media instead of an installed operating system stored on said computer;
loading network support code for said computer read from said removable physical media;
downloading from a remote computer one or more malware detection files; and
performing malware detection upon said computer using said one or more malware detection files.

Viewed from a further aspect the present invention provides a server computer connected by a network link to a computer detecting malware upon said computer by performing the steps of:
booting said computer with a non-installed operating system read from a removable physical media instead of an installed operating system stored on said computer;
loading network support code for said computer read from said removable physical media;
downloading from a server computer one or more malware detection files; and
performing malware detection upon said computer using said one or more malware detection files.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a computer network containing a computer to be subject to a clean boot;

FIG. 2 is a flow diagram schematically illustrating the processing performed as part of the clean boot operation and subsequent malware detection;

FIG. 3 is a flow diagram schematically illustrating the processing performed by a remote computer from which malware detection files are downloaded; and

FIG. 4 is a diagram schematically illustrating the architecture of a general purpose computer that may be used to implement the above techniques.

### DESCRIPTION OF THE PREFERRED EMBODIMENTS

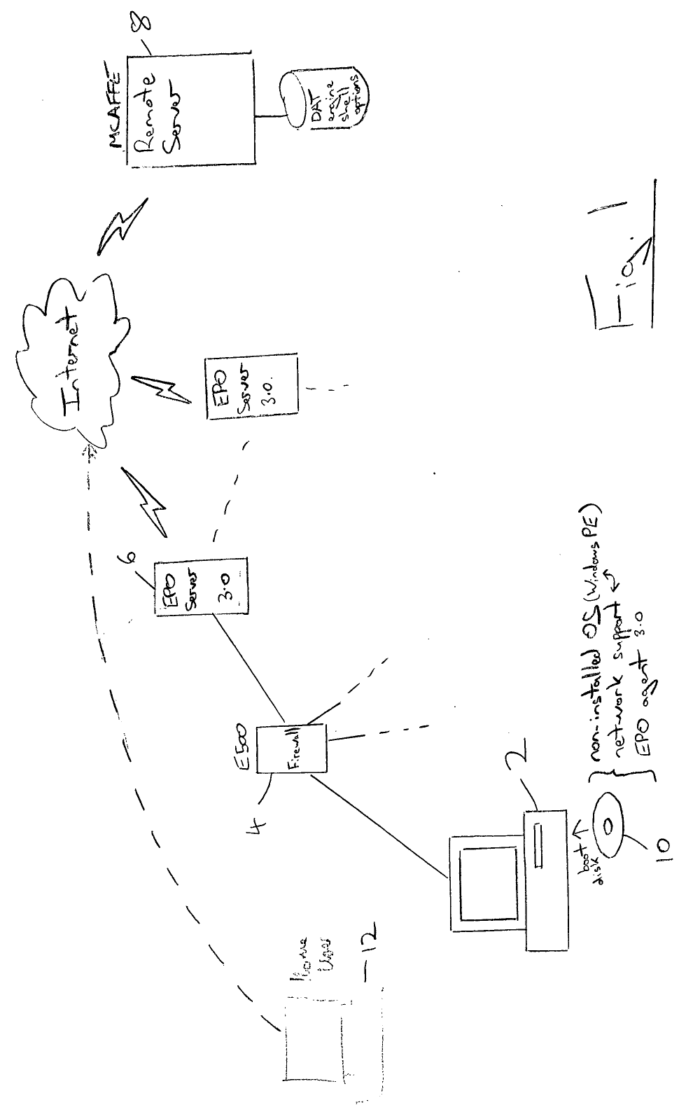

FIG. 1 illustrates a computer 2 connected via a firewall computer 4 (e.g. an E500 firewall computer as produced by Network Associates, Inc) to a remote server 6. The remote server 6 may be running a network security management computer program such as EPO 3.0 produced by Network Associates, Inc. The remote server 6 keeps an up-to-date copy of malware detection files including virus definition data (a DAT file), a virus detection engine file, a malware detecting application shell file and safe malware detection configuration options file which are themselves regularly downloaded from a malware detection software provider's remote server 8 via the internet. Thus, a single remote server 6 within an organisation can maintain the up-to-date copy of the malware detection files as controlled and managed by the system administrator. The individual computer users are issued with a removable physical media 10, such as a CD. This removable physical media could take other forms such as a floppy disk, a memory card, a removable disk drive or the like. The removable physical media 10 is a bootable disk from which the computer 2 may be booted using a non-installed operating system (such as Windows PE) which is carried by the removable physical media 10. This non-installed operating system also includes network support code to enable the computer 2 to establish a network connection via the firewall computer 4 to the remote server 6. When the computer 2 has booted to the non-installed operating system carried on the removable physical media 10, a security management program, such as EPO Agent 3.0 produced by Network Associates, Inc. is automatically loaded and run from the removable physical media 10. This security management program is configured to trigger a download of the up-to-date versions of the malware detection files necessary to perform a malware detection operation upon the computer 2. These malware detection files include the malware definition data, the malware scanning engine, the malware detection application shell and any malware detection system option settings. It will be appreciated that perhaps only a subset of these files need to be downloaded with the rest being provided upon the removable physical media. However, it is advantageous if all of these files are downloaded since this will guard against one of these elements becoming out-of-date.

It will be appreciated that the provision of the non-installed operation system on the removable physical media to provide the clean boot environment saves a significant amount of time and network capacity which would otherwise be consumed in attempting to download this clean operating system as part of a network booting operation. Furthermore, not all computers are able to support network booting and so the present technique which boots to a clean operating system from a removable physical media is advantageous since this is widely provided as a boot option by deployed computers.

Also illustrated in FIG. 1 is a home user computer 12. A home user may make a dial-up connection to the internet following a clean boot using a removable physical media and then download the necessary malware detecting files either from a remote server 6, as might be associated with that home user if they were part of a virtual private network, or alternatively from the malware provider's detecting software server 8.

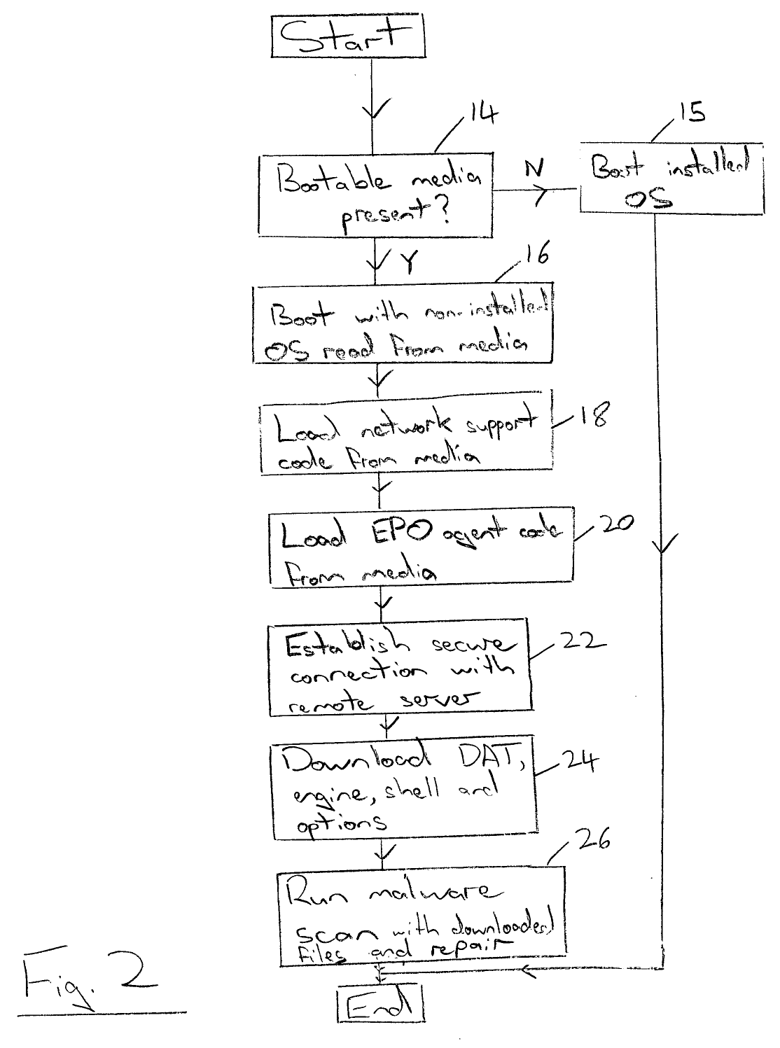

FIG. 2 schematically illustrates the processing operations performed upon the computer 2. At step 14 the computer checks to see if a bootable removable media is present. This assumes that the computer is configured in its BIOS settings to first try to boot from the removable media. If the removable media is not present then processing proceeds to step 15 at which the system boots using the normal installed operating system held on the computer's non-volatile storage device, such as its hard disk drive.

If a bootable removable physical media is detected at step 14, then processing proceeds to step 16 at which a boot is performed with a non-installed operating system read from the media. Step 18 then loads network support code from the media. This network support code may be an intrinsic part of the operating system loaded at step 16 or might alternatively be separately loaded from the media.

At step 20, the security management code, such as EPO Agent 3.0, is loaded and run from the media. The security management code serves to trigger a connection via a secure mechanism to be made with the remote server 6. This secure connection can use passwords for authentication and/or as deemed desirable. The secure connection established at step 22 is then used at step 24 as triggered by the security management code to download the malware detection files including the malware definition data, the malware detection engine, the malware detection application shell and the malware detection option settings. At step 26, the malware scan (detection) is then run using the downloaded and accordingly up-to-date files with any detected malware being subject to repair operations.

At an overall level, FIG. 2 illustrates booting to a clean non-installed operating system at steps 14 and 16, loading of network support code at step 18, downloading of malware detection files at step 24 and running of a malware detection operation at step 26.

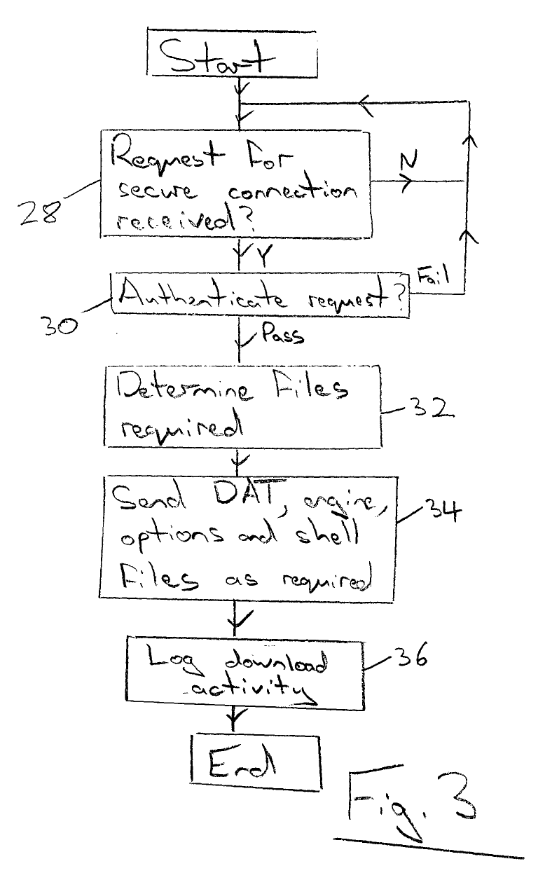

FIG. 3 schematically illustrates the processing which may be performed upon a remote server, such as the remote server 6 in FIG. 1, or the malware detection software provider's remote server 8 in FIG. 1. At step 28, the remote server waits for a secure connection request to be received. When a secure connection request has been received, then step 30 seeks to authenticate this request, e.g. by use of a password. If the authentication is successful, then step 32 serves to determine which malware detection files are appropriate to be provided to the computer making the request. Different operating systems and malware detecting products may be deployed across a network and accordingly the required malware definition data, malware detection engine, malware detection application shell and option files can be selected as appropriate. At step 34, the malware detection files determined to be necessary are sent to the computer. At step 36, the downloading of the malware detection files is logged by the remote computer. This logged information is useful to ensure that all computers within the network have performed the required clean boot operation or for other management reasons, such as recording what viruses are found and removed.

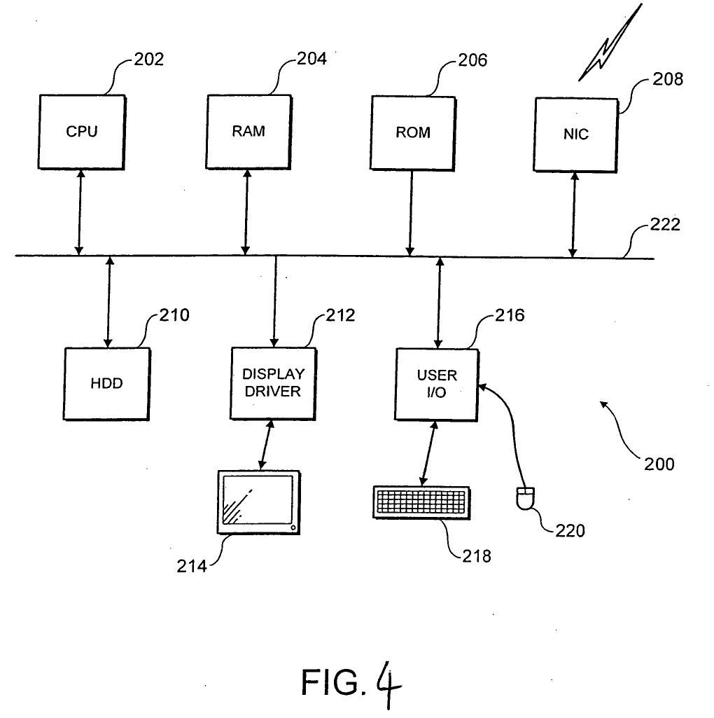

FIG. 4 schematically illustrates a general purpose computer 200 of the type that may be used to implement the above described techniques. The general purpose computer 200 includes a central processing unit 202, a random access memory 204, a read only memory 206, a network interface card 208, a hard disk drive 210, a display driver 212 and monitor 214 and a user input/output circuit 216 with a keyboard 218 and mouse 220 all connected via a common bus 222. In operation the central processing unit 202 will execute computer program instructions that may be stored in one or more of the random access memory 204, the read only memory 206 and the hard disk drive 210 or dynamically downloaded via the network interface card 208. The results of the processing performed may be displayed to a user via the display driver 212 and the monitor 214. User inputs for controlling the operation of the general purpose computer 200 may be received via the user input output circuit 216 from the keyboard 218 or the mouse 220. It will be appreciated that the computer program could be written in a variety of different computer languages. The computer program may be stored and distributed on a recording medium or dynamically downloaded to the general purpose computer 200. When operating under control of an appropriate computer program, the general purpose computer 200 can perform the above described techniques and can be considered to form an apparatus for performing the above described technique. The architecture of the general purpose computer 200 could vary considerably and FIG. 4 is only one example.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1. A removable physical media bearing a computer program operable to control a computer to detecting malware by performing the steps of:
booting said computer with a non-installed operating system read from said removable physical media instead of an installed operating system stored on said computer;
loading network support code for said computer read from said removable physical media;
downloading from a remote computer one or more malware detection files; and
performing malware detection upon said computer using said one or more malware detection files.

2. A removable physical media as claimed in claim 1, wherein said one or more malware detection files include at least one of:
malware definition data containing data characteristic of malware to be detected;
a malware detecting engine operable to control said computer to perform said malware detection;
a malware application shell; and
malware detection option settings operable to configure optional settings of said malware detection.

3. A removable physical media as claimed in claim 1, wherein said steps further comprise loading security management code operable to control said downloading.

4. A removable physical media as claimed in claim 1, wherein said steps further comprise establishing a secure network connection to said remote computer.

5. A removable physical media as claimed in 4, wherein a firewall computer disposed between said computer and said remote computer is operable to block a connection between said computer and said remote computer other than said secure network connection.

6. A removable physical media as claimed in claim 1, wherein said non-installed operating system is a Windows PE operating system.

7. A removable physical media as claimed in claim 1, wherein said removable physical media is one of:
an optical disk;
a floppy disk;
a memory card; and
a removable disk drive.

8. A removable physical media as claimed in claim 1, wherein malware to be detected includes one or more of:
a computer virus;
a computer Trojan;
a computer worm;
a banned computer application;
a data file associated with a malware file; and
configuration settings of said computer associated with a malware file.

9. A method of detecting malware upon a computer said method comprising the steps of:
booting said computer with a non-installed operating system read from a removable physical media instead of an installed operating system stored on said computer;
loading network support code for said computer read from said removable physical media;
downloading from a remote computer one or more malware detection files; and
performing malware detection upon said computer using said one or more malware detection files.

10. A method as claimed in claim 9, wherein said one or more malware detection files include at least one of:
malware definition data containing data characteristic of malware to be detected;
a malware detecting engine operable to control said computer to perform said malware detection;
a malware application shell; and
malware detection option settings operable to configure optional settings of said malware detection.

11. A method as claimed in claim 9, comprising loading security management code operable to control said downloading.

12. A method as claimed in claim 9, comprising establishing a secure network connection to said remote computer.

13. A method as claimed in 12, wherein a firewall computer disposed between said computer and said remote computer is operable to block a connection between said computer and said remote computer other than said secure network connection.

14. A method as claimed in claim 9, wherein said non-installed operating system is a Windows PE operating system.

15. A method as claimed in claim 9, wherein said removable physical media is one of:
an optical disk;
a floppy disk;
a memory card; and
a removable disk drive.

16. A method as claimed in claim 9, wherein malware to be detected includes one or more of:
a computer virus;
a computer Trojan;
a computer worm;
a banned computer application;
a data file associated with a malware file; and
configuration settings of said computer associated with a malware file.

17. A computer operable to detect malware upon said computer by performing the steps of:
booting said computer with a non-installed operating system read from a removable physical media instead of an installed operating system stored on said computer;
loading network support code for said computer read from said removable physical media;
downloading from a remote computer one or more malware detection files; and
performing malware detection upon said computer using said one or more malware detection files.

18. A computer as claimed in claim 17, wherein said one or more malware detection files include at least one of:
malware definition data containing data characteristic of malware to be detected;
a malware detecting engine operable to control said computer to perform said malware detection;
a malware application shell; and
malware detection option settings operable to configure optional settings of said malware detection.

19. A computer as claimed in claim 17, wherein said steps further comprise loading security management code operable to control said downloading.

20. A computer as claimed in claim 17, wherein said steps further comprise establishing a secure network connection to said remote computer.

21. A computer as claimed in 20, wherein a firewall computer disposed between said computer and said remote computer is operable to block a connection between said computer and said remote computer other than said secure network connection.

22. A computer as claimed in claim 17, wherein said non-installed operating system is a Windows PE operating system.

23. A computer as claimed in claim 17, wherein said removable physical media is one of:
an optical disk;
a floppy disk;
a memory card; and
a removable disk drive.

24. A computer as claimed in claim 17, wherein malware to be detected includes one or more of:
a computer virus;
a computer Trojan;
a computer worm;
a banned computer application;
a data file associated with a malware file; and
configuration settings of said computer associated with a malware file.

25. A server computer connected by a network link to a computer detecting malware upon said computer by performing the steps of:
booting said computer with a non-installed operating system read from a removable physical media instead of an installed operating system stored on said computer;
loading network support code for said computer read from said removable physical media;
downloading from a server computer one or more malware detection files; and performing malware detection upon said computer using said one or more malware detection files.
